(19) United States
(12) Patent Application Publication
(10) Pub. No.: US 2009/0224898 A1
(43) Pub. Date: Sep. 10, 2009

(54) Relocatable Machine Monitor

(75) Inventors: Joshua Dean Graeve, Peosta, IA (US); Brent Allen Smith, Peosta, IA (US); Darrel Jeffrey Rowan, Dubuque, IA (US)

Correspondence Address: BAKER & DANIELS LLP, 300 NORTH MERIDIAN STREET, SUITE 2700, INDIANAPOLIS, IN, 46204, US

(73) Assignee: DEERE & COMPANY, Moline, IL (US)

(21) Appl. No.: 12/044,207

(22) Filed: Mar. 7, 2008

(51) Int. Cl. B60Q 9/00; E02F 3/76

(52) U.S. Cl. 340/438; 37/381; 29/428

(57) ABSTRACT

A vehicle is disclosed having a relocatable monitor. Methods of installing the monitor are also disclosed.

### BACKGROUND

1. Field of the Invention

The present disclosure relates to a vehicle having a monitor. More particularly, the present disclosure relates to a vehicle having a relocatable monitor, and to methods for installing the same.

2. Description of the Related Art

Work vehicles may be provided with a blade for pushing, shearing, carrying, and leveling dirt and other material. Motor graders, for example, may be used in the construction and maintenance of roads to prepare flat surfaces. To assist an operator while operating the vehicle, the vehicle may include a monitor or display device.

### SUMMARY

According to an embodiment of the present disclosure, a vehicle is provided that includes a chassis, a ground engaging mechanism configured to support and propel the chassis, and an operator station within the chassis. The vehicle further includes at least one monitor and a plurality of installation locations within the operator station. Each installation location includes a mount and an electrical connector. The mount is configured to support the monitor. The electrical connector is configured to provide power, data, or both, to the monitor. During original manufacture of the vehicle, at least one of the installation locations lacks a monitor.

According to another embodiment of the present disclosure, a vehicle is provided that includes a chassis, a ground engaging mechanism configured to support and propel the chassis, and an operator station within the chassis. The vehicle further includes an OEM monitor, a first installation location within the operator station, and a second installation location within the operator station. The first installation location includes a mount configured to support the OEM monitor and an electrical connector configured to provide power, data, or both, to the OEM monitor. The second installation location also includes a mount configured to support the OEM monitor and an electrical connector configured to provide power, data, or both, to the OEM monitor. During original manufacture of the vehicle, the second installation location lacks a monitor.

According to yet another embodiment of the present disclosure, a method is provided for manufacturing a vehicle. The method involves providing, during original manufacture, the vehicle having a first installation location with an OEM monitor installed in the first installation location and a second installation location without a monitor installed in the second installation location. The first installation location includes a mount configured to support the OEM monitor and an electrical connector configured to provide power, data, or both to the OEM monitor. The second installation location also includes a mount configured to support the OEM monitor and an electrical connector configured to provide power, data, or both, to the OEM monitor.

According to still yet another embodiment of the present disclosure, a method is provided for installing a monitor in a vehicle. During original manufacture, the method involves providing the vehicle having a first installation location with a first monitor and a second installation location without a monitor. Each installation location includes a mount configured to support the first monitor and an electrical connector configured to provide power, data, or both, to the first monitor. After providing the vehicle, the method involves installing a second monitor in either the first installation location or the second installation location.

### BRIEF DESCRIPTION OF THE DRAWINGS

The above-mentioned and other features of the present disclosure will become more apparent and the present disclosure itself will be better understood by reference to the following description of embodiments of the present disclosure taken in conjunction with the accompanying drawings, wherein:

FIG. 1 is a side view of a vehicle of the present disclosure;

FIG. 2 is a perspective view of an operator station of the vehicle having multiple installation locations;

FIG. 3 is a view similar to FIG. 2 of the operator station having a first monitor installed in one of the installation locations; and

FIG. 4 is a view similar to FIG. 3 of the operator station having the first monitor installed in one of the installation locations and a second monitor installed in another of the installation locations.

Corresponding reference characters indicate corresponding parts throughout the several views. The exemplifications set out herein illustrate exemplary embodiments of the invention and such exemplifications are not to be construed as limiting the scope of the invention in any manner.

### DETAILED DESCRIPTION

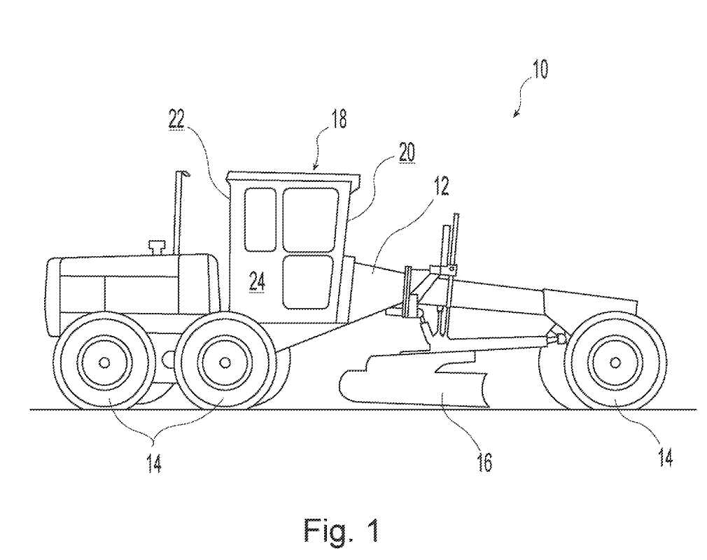

Referring to FIG. 1, a vehicle in the form of motor grader 10 is provided. Although the vehicle is illustrated and described herein as motor grader 10, the vehicle may include any other type of vehicle including, for example, a tractor, an excavator, and a bulldozer. Motor grader 10 includes chassis 12 and ground engaging mechanism 14. Ground engaging mechanism 14 may include any device capable of supporting and/or propelling chassis 12. For example, as illustrated in FIG. 1, ground engaging mechanism 14 may include wheels. Motor grader 10 also includes blade 16 mounted to chassis 12 for pushing, spreading, and leveling dirt and other material.

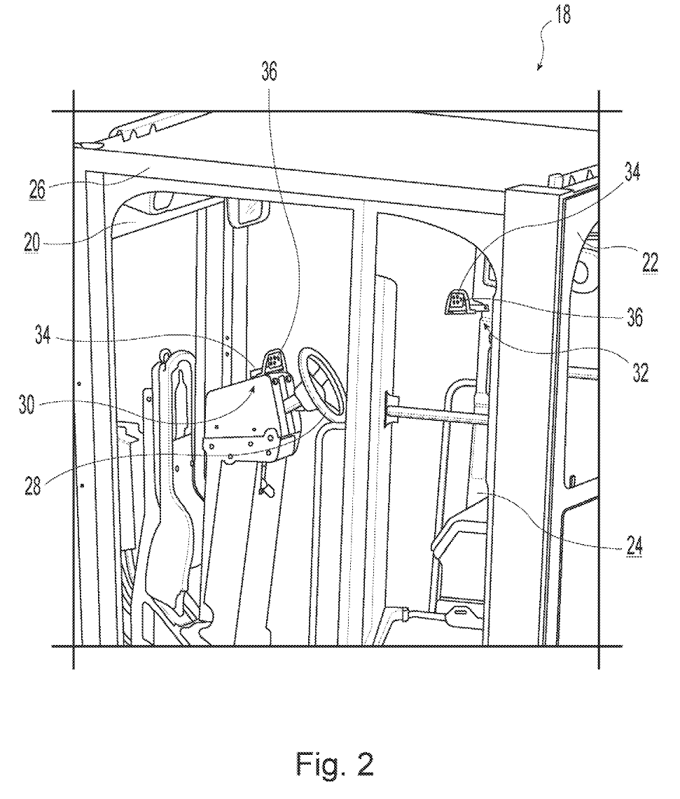

Referring to FIGS. 1-2, motor grader 10 further includes operator station 18 for an operator of motor grader 10. As shown, operator station 18 includes exterior walls that may surround and protect the operator within operator station 18, including front wall 20, rear wall 22, and side walls 24, 26. The operator may face front wall 20 during operation of motor grader 10. The exterior walls of operator station 18, including front wall 20, may include windows or openings to provide the operator with an adequate line of sight beyond operator station 18. While operating motor grader 10, the operator should have an adequate view of the ground, any obstacles on the ground, and, if applicable, blade 16. Operator station 18 of motor grader 10 further includes steering mechanism 28, such as a steering wheel, configured to steer motor grader 10 during operation. Steering mechanism 28 may be located toward front wall 20 of operator station 18.

Referring to FIG. 2, operator station 18 of motor grader 10 further includes a plurality of installation locations, illustrated herein as first installation location 30 and second installation location 32. First installation location 30 may be located toward front wall 20 of operator station 18. More specifically, first installation location 30 may be located above steering mechanism 28 toward front wall 20 of operator station 18. Second installation location 32 may be located on side wall 24 or side wall 26 of operator station 18. Both first installation location 30 and second installation location 32 may include mount 34 and/or electrical connector 36.

Mount 34 may include any device or arrangement configured to support a monitor or display device. For example, as shown in FIG. 2, mount 34 may include a U-shaped bracket configured to be secured onto an exterior wall of operator station 18 and screwed, bolted, or otherwise secured to a monitor. In this form, the bracket may include an adjustable and movable arm. Another example of mount 34 is a plate configured to be secured onto an exterior wall of operator station 18 and slid into a receptacle within a monitor. Yet another example of mount 34 is at least one hole within an exterior wall of operator station 18 configured to receive a screw, a bolt, or another fastener from a monitor.

Electrical connector 36 may include any device configured to provide power, data, or both, to a monitor or display device. For example, electrical connector 36 may include a universal serial bus (USB) connector, a VGA connector, a digital video interface (DVI) connector, an RCA connector, or an S-video connector. Electrical connector 36 may also include a purpose-built harness with, for example, Deutsch or Metri-Pack connectors.

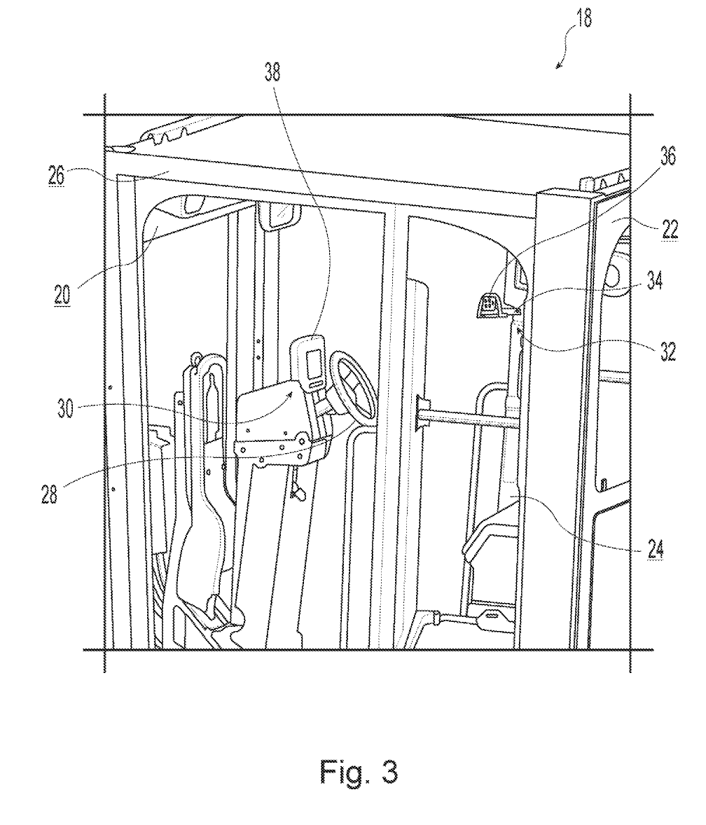

According to an embodiment of the present disclosure, illustrated in FIG. 3, motor grader 10 may be provided during original manufacture with first monitor 38. As used herein, “original manufacture” includes the period before motor grader 10 is sold and delivered to a third party, such as a distributor or a customer. First monitor 38 may be a device of the original equipment manufacturer (OEM). As used herein, an “OEM monitor” includes a monitor that is installed in motor grader 10 during original manufacture of motor grader 10. An “OEM monitor” may be manufactured by the manufacturer of motor grader 10 or by a third party. As shown, first monitor 38 may be installed in first installation location 30. In other words, first monitor 38 may be installed above steering mechanism 28 toward front wall 20 of operator station 18. First monitor 38 may be attached to mount 34 of first installation location 30 and may be connected to electrical connector 36 of first installation location 30 to receive power, data, or both. In an exemplary embodiment of the present disclosure, first monitor 38 installed in first installation location 30 should be within the operator's line of sight without significantly obstructing the operator's line of sight beyond operator station 18.

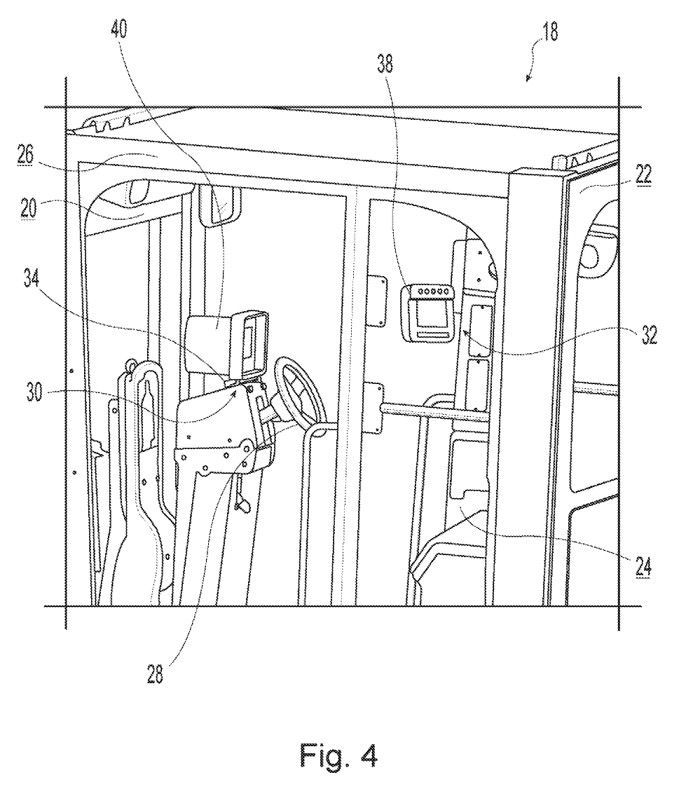

According to another embodiment of the present disclosure, illustrated in FIG. 4, second monitor 40 may be provided after original manufacture of motor grader 10 and mounted in first installation location 30. Second monitor 40 may be an after-market device installed after motor grader 10 is sold and delivered to a third party. Second monitor 40 may be supplied by a different manufacturer than motor grader 10 and, if applicable, by a different manufacturer than first monitor 38. Second monitor 40 may be part of a supplemental control system. For example, second monitor 40 may be part of a supplemental grade control system used to monitor the operation and maneuvers of blade 16. Using second monitor 40, the operator may view the actual position of blade 16 in relation to a digital design plan.

As shown in FIG. 4, first monitor 38 may be moved from first installation location 30 to second installation location 32 to accommodate second monitor 40. In other words, first monitor 38 may be moved from front wall 20 of operator station 18 to side wall 24 or side wall 26 of operator station 18. To relocate first monitor 38, first monitor 38 may be detached from mount 34 of first installation location 30 and disconnected from electrical connector 36 of first installation location 30. Then, without having to install a bracket in second installation location 32 or run wires to second installation location 32, first monitor 38 may be attached to existing mount 34 of second installation location 32 and may be connected to existing electrical connector 36 of second installation location 32 to receive power, data, or both. In an exemplary embodiment of the present disclosure, first monitor 38 installed in second installation location 32 should be within the operator's line of sight without significantly obstructing the operator's line of sight to second monitor 40 or the operator's line of site beyond operator station 18.

As shown in FIG. 4, second monitor 40 may replace first monitor 38 in first installation location 30. In other words, second monitor 40 may be installed above steering mechanism 28 toward front wall 20 of operator station 18. Second monitor 40 may be supported by mount 34 of first installation location 30 and may be connected to electrical connector 36 of first installation location 30 to receive power, data, or both. In an exemplary embodiment of the present disclosure, second monitor 40 installed in first installation location 30, like first monitor 38 previously installed in first installation location 30, should be within the operator's line of sight without significantly obstructing the operator's line of sight to first monitor 38 or the operator's line of site beyond operator station 18.

It is within the scope of the present disclosure that first monitor 38 may remain in first installation location 30, while second monitor 40 may be installed in second installation location 32. Similarly, it is within the scope of the present disclosure that first monitor 38 and second monitor 40 may be moved back and forth between first installation location 30 and second installation location 32, depending on the operator's preference and/or the operator's current use of motor grader 10.

The present disclosure is not limited to first installation location 30 and second installation location 32. For example, motor grader 10 may be provided with a third installation location to accommodate a third monitor. In an exemplary embodiment of the present disclosure, the third monitor installed in the third installation location should be within the operator's line of sight without significantly obstructing the operator's line of sight to the other monitors or the operator's line of sight beyond operator station 18.

While this invention has been described as having preferred designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A vehicle including:
a chassis;
a ground engaging mechanism configured to support and propel the chassis;
an operator station supported by the chassis;
at least one monitor; and
a plurality of installation locations within the operator station, each installation location including at least one of a mount and an electrical connector, the mount being configured to support the at least one monitor and the electrical connector being configured to provide at least one of power and data to the at least one monitor, and wherein at least one of the plurality of installation locations lacks a monitor during original manufacture of the vehicle.

2. The vehicle of claim 1, wherein the at least one monitor is an OEM device that is pre-installed in one of the plurality of installation locations during original manufacture of the vehicle.

3. The vehicle of claim 1, further including a second monitor installed in one of the plurality of installation locations after original manufacture of the vehicle.

4. The vehicle of claim 3, wherein the vehicle includes a blade, and the second monitor is configured to display maneuvers of the blade.

5. The vehicle of claim 1, wherein, after original manufacture of the vehicle, the at least one monitor is installed in the at least one of the plurality of installation locations lacking a monitor during original manufacture of the vehicle.

6. A vehicle including:
a chassis;
a ground engaging mechanism configured to support and propel the chassis;
an operator station supported by the chassis;
an OEM monitor;
a first installation location within the operator station, the first installation location including at least one of a mount configured to support the OEM monitor and an electrical connector configured to provide at least one of power and data to the OEM monitor; and
a second installation location within the operator station including at least one of a mount configured to support the OEM monitor and an electrical connector configured to provide at least one of power and data to the OEM monitor, wherein the second installation location lacks a monitor during original manufacture of the vehicle.

7. The vehicle of claim 6, wherein the OEM monitor is pre-installed in the first installation location during original manufacture of the vehicle.

8. The vehicle of claim 6, further including a second monitor, wherein the mount of the first installation location is configured to support the second monitor and the electrical connector of the first installation location is configured to provide at least one of power and data to the second monitor.

9. The vehicle of claim 8, wherein the second monitor is installed in the first installation location and the OEM monitor is installed in the second installation location.

10. The vehicle of claim 8, wherein the second monitor is an after-market device.

11. The vehicle of claim 8, wherein the vehicle includes a blade, and the second monitor is configured to display maneuvers of the blade.

12. The vehicle of claim 6, wherein the second installation location is located toward a lateral side of the operator station.

13. The vehicle of claim 6, wherein the first installation location is located toward a front of the operator station.

14. A method of manufacturing a vehicle having a chassis, a ground engaging mechanism configured to support and propel the chassis, and an operator station supported by the chassis, including the steps of:
providing, during original manufacture, a first installation location within the operator station with an OEM monitor installed in the first installation location, the first installation location including at least one of a mount configured to support the OEM monitor and an electrical connector configured to provide at least one of power and data to the OEM monitor; and
providing, during original manufacture, a second installation location within the operator station without a monitor installed in the second installation location, the second installation location including at least one of a mount configured to support the OEM monitor and an electrical connector configured to provide at least one of power and data to the OEM monitor.

15. The method of claim 14, further including the step of moving the OEM monitor from the first installation location to the second installation location after original manufacture of the vehicle.

16. The method of claim 15, further including the step of installing a second monitor in the first installation location after removing the OEM monitor from the first installation location.

17. The method of claim 14, further including the step of installing a second monitor in the vehicle after original manufacture of the vehicle.

18. The method of claim 17, further including the step of monitoring maneuvers of a blade of the vehicle using the second monitor.

19. A method of installing a monitor in a vehicle including the steps of:
providing, during original manufacture, the vehicle having:
a chassis;
a ground engaging mechanism configured to support and propel the chassis;
an operator station supported by the chassis;
a first installation location within the operator station with a first monitor, the first installation location including at least one of a mount configured to support the first monitor and an electrical connector configured to provide at least one of power and data to the first monitor;
a second installation location without a monitor, the second installation location including at least one of a mount configured to support the first monitor and an electrical connector configured to provide at least one of power and data to the first monitor; and
after providing the vehicle, installing a second monitor in one of the first and the second installation locations.

20. The method of claim 19, wherein the first monitor is installed by a manufacturer of the vehicle.

21. The method of claim 19, wherein the step of installing the second monitor occurs after sale and delivery of the vehicle.

22. The method of claim 19, further including the step of removing the first monitor from the first installation location before installing the second monitor.

23. The method of claim 19, wherein installing the second monitor includes the steps of:
securing the second monitor to the mount in one of the first and the second installation locations; and
connecting the second monitor to the electrical connector in one of the first and the second installation locations.

24. The method of claim 19, further including the step of monitoring maneuvers of a blade of the vehicle using the second monitor.
